(19) United States
(12) Patent Application Publication
(10) Pub. No.: US 2009/0141615 A1
(43) Pub. Date: Jun. 4, 2009

(54) OPTICAL RECORDING MEDIUM

(76) Inventors: Tsukasa NAKAI, Hino-shi (JP); Yasuhiro Satoh, Yokohama-shi (JP); Nobuaki Kaji, Yokohama-shi (JP); Sumio Ashida, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/244,040

(22) Filed: Oct. 2, 2008

(30) Foreign Application Priority Data
Nov. 30, 2007 (JP) 2007-311420

(51) Int. Cl. G11B 7/00

(52) U.S. Cl. 369/112.23; 369/100; G9B/7

(57) ABSTRACT

According to one embodiment, an optical recording medium according to one embodiment of the invention is an optical recording medium to be processed using a light beam having a wavelength λ and a lens having a numerical aperture NA, which includes one of a track and a pit array, and in which a width TP of the track or pit satisfies a condition 0.480≦TP×NA/λ<1.026.

### CROSS-REFERENCE TO RELATED APPLICATIONS

This application is based upon and claims the benefit of priority from Japanese Patent Application No. 2007-311420, filed Nov. 30, 2007, the entire contents of which are incorporated herein by reference.

### BACKGROUND

1. Field

One embodiment of the invention relates to an optical recording medium which records information by reversibly changing the state by light beam irradiation and, more particularly, to a phase-change optical recording medium whose state changes as the atomic arrangement of a thin film for holding recording causes transition between an amorphous state and a crystalline state. One embodiment of the invention also relates to an information playback apparatus, information playback method, information recording apparatus, and information recording method of processing the optical recording medium.

2. Description of the Related Art

Along with the recent proliferation of digital information processing devices, for example, Jpn. Pat. Appln. KOKAI Publication No. 2005-135490 proposes a phase-change optical recording medium that is outstanding in its high density, large capacity, and high-speed overwrite capability.

Limits of recording/playback of an optical recording medium will be explained here. For a so-called optical disk such as a CD or DVD or an optical recording medium, which uses no physical phenomenon such as super-resolution below the diffraction limit, the limit value, i.e., the lower limit of the mark size when recording a signal on the medium and in a playback process of reading a recorded signal is determined by the arrangement of the optical system such as a lens and the medium to be used. Especially, the numerical aperture (NA) of the objective lens used in the optical pickup and the substrate thickness or cover layer thickness of the medium on the light incident side are very important factors as well as the waveform of light to be used. That is, the NA of the objective lens to be used decides the degree of light diameter reduction by the light diffraction phenomenon. In an optical recording medium such as a CD or DVD, light, i.e., a laser beam to be used is focused to almost the diffraction limit and used for recording and playback. As for playback, a method has been proposed to read, i.e., play back, a signal below the diffraction limit by using various kinds of signal processing techniques mainly in a direction perpendicular to the radial direction of the medium, i.e., the pit array direction or tangential direction. In fact, the signal processing method takes measures assuming a case that no signal is recorded actually, or a signal is recorded but is very weak and undetectable. Whether a signal can be recorded or not rarely influences playback of the signal. It is therefore hard to think that the technique can actually read a signal below the diffraction limit. On the other hand, no definite recording method has been disclosed yet, and there is room for further study. Additionally, to record or play back a signal below the diffraction limit using a beam almost equal to the diffraction limit has been examined scarcely because it is normally considered to be beyond the capability of the system.

Various definitions are possible for the beam diameter and diffraction limit, and they will be defined here as follows. For the beam diameter, a laser beam is assumed whose intensity distribution can be approximated by a Gaussian distribution. The diameter of a beam with a beam intensity 1/e² will be defined as the beam diameter. A pit size below the diffraction limit to be described below will be defined as a size about ⅓ or less of the beam diameter in the direction perpendicular to the radial direction of the medium, i.e., the pit array direction. The currently substantiated level is 33% or less. This indicates a pit size which makes it difficult to accurately read a signal using light focused to almost the diffraction limit. On the other hand, in the radial direction of the medium, the size below the diffraction limit indicates the width of a write or read track or pit array which is ½ or less of the beam diameter. The currently substantiated level is 66% or less. The size of a non-write or non-read track is irrelevant. The size also indicates a track width which makes it difficult to accurately read a signal using light focused to almost the diffraction limit.

Note that the beam diameter is defined in a region where the beam is focused most. When a laser beam is used, the beam diameter is close to a so-called beam waist. Hence, the beam diameter is defined based on the NA of the lens system used in the optical pickup and the substrate thickness of the recording medium.

Since the information amount tends to increase in recent years, demands for an optical recording medium more suitable for high-density recording are growing.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are sectional views of an optical recording medium according to an embodiment of the invention;

FIGS. 2A and 2B are views for explaining the definition of the track width (TB) of the optical recording medium according to the embodiment;

FIG. 3 is a schematic view showing an example of an information recording/playback apparatus (optical disk apparatus) according to the embodiment;

FIG. 4 is a schematic view showing an optical head (PUH) mounted in the optical disk apparatus shown in FIG. 3;

FIG. 5 is a view for explaining the cavity length of a laser element incorporated in the PUH shown in FIG. 4;

FIGS. 6A to 6D are timing charts for explaining the relationship between light emission of the laser element and a laser driving current;

FIG. 7 is a timing chart showing an example of the output waveform of a pulse laser output from the laser element;

FIGS. 8A to 8C are views for explaining the relationship between the driving current supplied to the laser element of the PUH shown in FIG. 4, the laser output waveform, and a recording mark formed on a recording film (recording mark forming process);

FIG. 9 is a timing chart for explaining the relationship between a time T1 and the laser output waveform shown in FIGS. 6A to 6D;

FIG. 10 is a timing chart for explaining the waveform of a relaxation oscillation pulse when the cavity length of the laser element incorporated in the PUH shown in FIG. 4 is 800 μm;

FIG. 11 is a timing chart for explaining a laser oscillation condition to obtain the laser output waveform shown in FIG. 8B;

FIG. 12 is a timing chart for explaining the relationship between data (NRZI) recorded by “sub-nano-pulse recording” explained based on FIGS. 1A to 9 and a corresponding driving current waveform of a laser diode (LD);

FIG. 13 is a schematic view of a process chamber according to the embodiment; and

FIG. 14 is a flowchart illustrating a film forming process according to the embodiment.

### DETAILED DESCRIPTION

Various embodiments according to the invention will be described hereinafter with reference to the accompanying drawings. In general, an optical recording medium according to one embodiment of the invention is an optical recording medium to be processed using a light beam having a wavelength λ and a lens having a numerical aperture NA, which comprises one of a track and a pit array, and in which a width TP of the track or pit satisfies a condition 0.480≦TP×NA/λ<1.026.

Sufficiently considering the above-described viewpoint, the present inventors came to the conclusion that the following points are important. Based on a track width (TB) or pit array width (TB) of an optical recording medium, the numerical aperture NA of the optical system of the optical pickup used in an optical disk apparatus for recording/playing back data on/from the optical recording medium, and the wavelength λ of light used for recording/playback, an optical recording medium that satisfies 0.480≦TP×NA/λ<1.026 is preferable. When the wavelength is 780 nm, 0.769≦TP×NA/λ<1.026 is more preferable. Even the prior art can cope with the upper limit value TP×NA/λ=1.026, though a smaller value is hard to deal with. The range smaller than the lower limit value TP×NA/λ=0.480 is not preferable because the track width is much smaller than the beam diameter to be used, and the effect is poor. When the wavelength is 650 nm, 0.530≦TP×NA/λ<0.683 is more preferable. Similarly, even the prior art can cope with the upper limit value TP×NA/λ=0.683, though a smaller value is hard to deal with. The range smaller than the lower limit value TP×NA/λ=0.530 is not preferable because the track width is much smaller than the beam diameter to be used, and the effect is poor. When the wavelength is 405 nm, 0.481≦TP×NA/λ<0.672 is more preferable. Similarly, even the prior art can cope with the upper limit value TP×NA/λ=0.672, though a smaller value is hard to deal with. The range smaller than the lower limit value TP×NA/λ=0.481 is not preferable because the track width is much smaller than the beam diameter to be used, and the effect of this embodiment is poor.

Based on the track width (TB) or pit array width (TB) of the optical recording medium, the numerical aperture NA of the optical system of the optical pickup used in the optical disk apparatus for recording/playing back data on/from the optical recording medium, and the wavelength λ of light used for recording/playback, a recording/playback apparatus for recording/playing back data on/from an optical recording medium that satisfies 0.480≦TP×NA/λ<1.026 is preferable. When the wavelength is 780 nm, 0.769≦TP×NA/λ<1.026 is more preferable. When the wavelength is 650 nm, 0.530≦TP×NA/λ<0.683 is more preferable. When the wavelength is 405 nm, 0.481≦TP×NA/λ<0.672 is more preferable. The circumstances about the conditions are the same as described above.

Based on the track width (TB) or pit array width of the optical recording medium, the numerical aperture NA of the optical system of the optical pickup used in the optical disk apparatus for recording/playing back data on/from the optical recording medium, and the wavelength λ of light used for recording/playback, a method of recording/playing back data on/from an optical recording medium that satisfies 0.480≦TP×NA/λ<1.026 is preferable. When the wavelength is 780 nm, 0.769≦TP×NA/λ<1.026 is more preferable. When the wavelength is 650 nm, 0.530≦TP×NA/λ<0.683 is more preferable. When the wavelength is 405 nm, 0.481≦TP×NA/λ<0.672 is more preferable. The circumstances about the conditions are the same as described above.

In the optical recording medium, when a recording film contains at least Ge, Sb, and Te, and its composition is represented by GeₓSb_{y}Te_{z} (x+y+z=100), the composition region is preferably defined by x=55/z=45, x=45/z=55, x=10/y=28/z=42, and x=10/y=36/z=54 on the GeSbTe ternary phase diagram.

The recording film is obtained by sputtering method using a sputtering target having the above composition and an inert gas such as Ar. Ge in the recording film relatively easily oxidizes. The sputtering target of the starting material and the inert gas such as Ar used for sputter deposition contain oxygen in a very small amount. For this reason, the recording film inevitably contains a small amount of oxygen. Additionally, when an oxide thin film is used as a layer in contact with the recording film, a small amount of oxygen is diffused into the recording film, resulting in a further increase in the oxygen amount. However, the embodiment can be implemented without departing from its scope even when not only Ge, Sb, and Te but also oxygen (O) is detected in the recording film. As is well known about the recording film, the composition of a sputtering target and that of a thin film formed under various conditions are slightly different. Generally, the compositions are recognized as the same, except for a special case, if the difference is about ±1 at. %. The same shall apply hereinafter.

In the optical recording medium, when the composition of the recording film is partially substituted with bismuth (Bi) and/or indium (In) and/or tin (Sn), and the composition after substitution is represented by (Ge_{(1-w)}Sn_{w})ₓ(Sb₍₁₋ᵥ₎(Bi₍₁₋ᵤ₎Inᵤ)ᵥ)_{y}Te_{z} (x+y+z=100), w, v, and u of the composition preferably satisfy 0≦w<0.5, 0<v<1, and 0≦u≦0.7.

In the optical recording medium, when the recording film contains at least Ge, Bi, and Te, and its composition is represented by GeₓBi_{y}Te_{z} (x+y+z=100), the composition region is preferably defined by x=55/z=45, x=45/z=55, x=10/y=28/z=42, and x=10/y=36/z=54 on the GeBiTe ternary phase diagram.

In the optical recording medium, when the recording film contains at least Ge, Sb, Te, and nitrogen (N), and the composition of Ge, Sb, and Te is represented by GeₓSb_{y}Te_{z} (x+y+z=100), nitrogen (N) is preferably added in 1 to 5 at. % to a GeSbTe compound in a composition region defined by x=55/z=45, x=45/z=55, x=10/y=28/z=42, and x=10/y=36/z=54 on the GeSbTe ternary phase diagram.

In this case as well, the recording film is obtained by sputtering method using a sputtering target having the above composition and an inert gas such as Ar. Ge in the recording film relatively easily oxidizes. The sputtering target of the starting material and the inert gas such as Ar used for sputter deposition contain oxygen in a very small amount. When a gas containing nitrogen (N₂) is used as the sputtering gas, it also contains oxygen (O) in a very small amount. For this reason, the recording film inevitably contains a small amount of oxygen. Additionally, when an oxide thin film is used as a layer in contact with the recording film, a small amount of oxygen is diffused into the recording film, resulting in a further increase in the oxygen amount. However, the embodiment can be implemented without departing from its scope even when not only Ge, Sb, and Te but also oxygen (O) is detected in the recording film. The same shall apply hereinafter.

In the optical recording medium, when the composition of the recording film is partially substituted with bismuth (Bi) and/or indium (In) and/or tin (Sn), and the composition after substitution is represented by (Ge_{(1-w)}Sn_{w})ₓ(Sb₍₁₋ᵥ₎(Bi₍₁₋ᵤ₎Inᵤ)ᵥ)_{y}Te_{z} (x+y+z=100), preferably, w, v, and u of the composition satisfy 0≦w<0.5, 0<v<1, and 0≦u≦0.7, and nitrogen (N) is added in 1 to 5 at. % to a GeSnSbTe, GeSnSbTeIn, GeSbTeIn, GeSbTeBiIn, GeSbSnTeBiIn, GeSbTeBi, GeSnSbTeBi, or GeSnSbTeBiIn compound having the above composition.

In the optical recording medium, when the recording film contains at least Ge, Bi, Te, and nitrogen (N), and the composition of Ge, Bi, and Te is represented by GeₓBi_{y}Te_{z} (x+y+z=100), nitrogen (N) is preferably added in 1 to 5 at. % to a GeBiTe compound in a composition region defined by x=55/z=45, x=45/z=55, x=10/y=28/z=42, and x=10/y=36/z=54 on the GeBiTe ternary phase diagram.

In the optical recording medium, when the recording film contains at least Sb and Te, and its composition is represented by SbₐTe₁₋ₐ, a preferably satisfies 0.6≦a≦0.81.

In the optical recording medium, when the recording film contains at least Ga and Sb, and its composition is represented by Ga_{b}Sb_{1-b}, b preferably satisfies 0.09≦b≦0.35.

In the optical recording medium, when the recording film contains at least In and Sb, and its composition is represented by In_{c}Sb_{1-c}, c preferably satisfies 0.15≦c≦0.4.

In the optical recording medium, when the recording film contains at least Ga and Sb, and its composition is represented by Ga_{d}Sb_{1-d}, d preferably satisfies 0.10≦d≦0.35.

In the optical recording medium, when the recording film contains at least Ga, In, and Sb, and its composition is represented by (InSb)ₑ(GaSb)₁₋ₑ, e preferably satisfies 0≦e<1.

In the optical recording medium, preferably, a recording film formed by adding nitrogen to GeSbTe, GeBiTe, GeSbTeBi, or the like is used as the recording film, and an interface layer selected from GeN, GeCrN, ZrO₂+Cr₂O₃, ZrSiO₄, ZrO₂₋ₓNₓ containing Y₂O₃, ZrO₂₋ₓNₓ+Cr₂O₃ containing Y₂O₃, and ZrSiO₄₋ₓ_{N}ₓ is used as at least one of the layers in contact with the recording film. ZrO₂₋ₓNₓ containing Y₂O₃ or ZrO₂₋ₓNₓ+Cr₂O₃ containing Y₂O₃ is not necessarily referred to as a layer containing Y₂O₃.

In the optical recording medium, preferably, a recording film based on SbTe, InSb, GaSb, GeSb, or the like is used as the recording film, and a layer selected from SiN, GeN, and SiC is used as at least one of the layers in contact with the recording film.

The optical recording/playback apparatus or recording/playback method preferably uses a waveform, pulse train, or so-called relaxation oscillation in which the rise time of an optical pulse used in recording falls within the range of 0.1 to 0.9 ns (inclusive).

The materials and composition of the recording film are preferably selected within the above-described ranges in accordance with the required crystallization speed and medium sensitivity, and the optical characteristics of the medium, including the reflectance, contrast, and transmittance.

A detailed description will now be given with reference to the accompanying drawing.

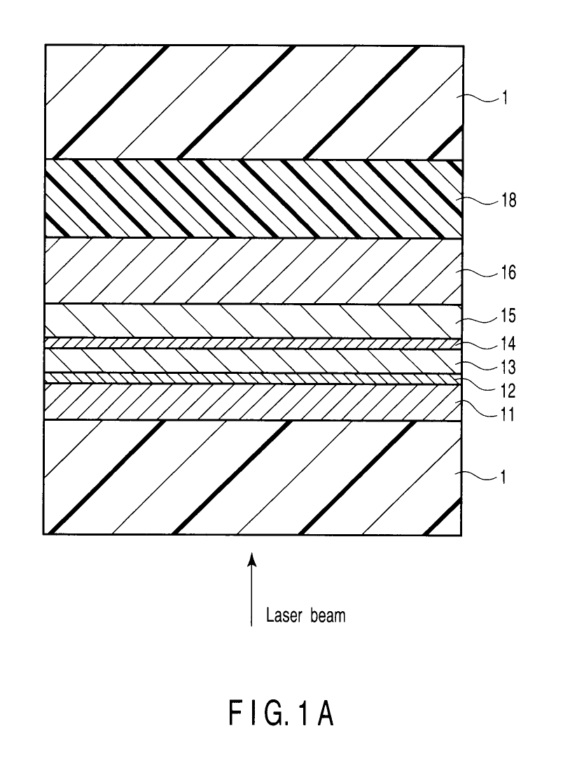

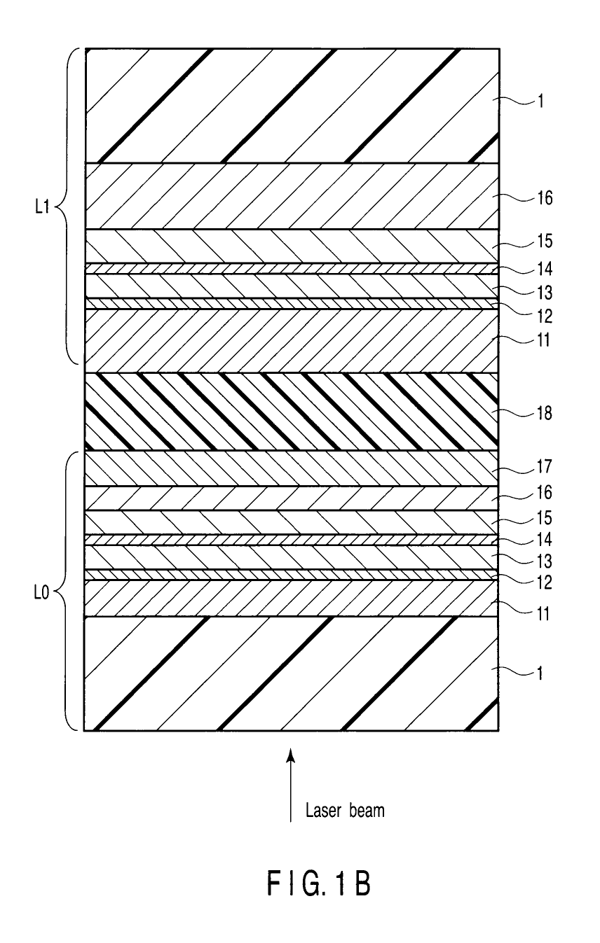

FIGS. 1A and 1B show examples of the layer structure of the recording medium according to this embodiment. FIG. 1A shows an example of a single-sided single-layer medium. FIG. 1B shows an example of a single-sided double (dual)-layer medium. In the single-sided single-layer medium, a first interference film 11, a lower interface film 12, recording film 13, an upper interface film 14, a second interference film 15, and a reflecting film 16 are stacked on a transparent substrate 1 sequentially from the light incident side, and the resultant structure is bonded to a substrate having no films formed on it via an adhesive layer 18. In the single-sided double-layer medium, an information layer L0 is formed by stacking the first interference film 11, the lower interface film 12, the recording film 13, the upper interface film 14, the second interference film 15, the reflecting film 16, and a third interference film 17 on the transparent substrate 1 sequentially from the light incident side. An information layer L1 is formed by conversely stacking the reflecting film 16, the second interference film 15, the upper interface film 14, the recording film 13, the lower interface film 12, and the first interference film 11 sequentially on the transparent substrate 1. Then, the information layers are bonded via the interlayer separation layer 18 serving as the adhesive layer.

The arrangement of the phase-change optical recording medium according to the embodiment of the invention is not limited to those shown in FIGS. 1A and 1B. For example, a dielectric film may be inserted between the second interference film 15 and the reflecting film 16. All the interference films may be omitted by substituting them with the material of the interface films. The reflecting film may be omitted. The reflecting film may be formed from a plurality of metal films. An additional dielectric film may be formed on the reflecting film. As a minimum arrangement, the L0 information layer 19 is formed by stacking the first interference film 11, the recording film 13, the second interference film 15, the reflecting film 16, and the third interference film 17 on the transparent substrate 1 sequentially from the light incident side. The L1 information layer 20 is formed by conversely stacking the reflecting film 16, the second interference film 15, the recording film 13, and the first interference film 11 sequentially on the transparent substrate 1. Then, the information layers are bonded via the interlayer separation layer 18 serving as an adhesive layer.

For the double-layer medium, a first information layer (L0) close to the light incident surface and a second information layer (L1) far from the light incident surface, which have the above-described structures, are formed and bonded via an adhesive layer to ensure interlayer separation. The same arrangement applies to a multilayer medium including three or more layers.

Alternatively, various films may be formed on a substrate, and an approximately 0.1-mm-thick transparent sheet may be bonded onto the resultant structure so that light becomes incident via the transparent sheet (this medium assumes use of an objective lens having a high NA of about 0.85). This is because the medium using the 0.1-mm-thick transparent cover layer on the light incident side and a medium using a 0.6-mm-thick transparent substrate, as mainly used in this embodiment, make little difference in terms of characteristics required of the recording film, interface layer materials, protective film materials, and reflecting film materials to be used.

The embodiment to be described below shows an example of a single-sided single-layer medium. The single-layer medium has almost the same structure as L1 of the single-sided double-layer medium. As the measurement data of prototype optical disks, the worst values in the lands (L) and grooves (G) of L0 and L1 in experiments are shown as representative values. As, e.g., SbER, the largest value of obtained data is presented as the representative value. For CNR or erase ratio (ER), the smallest value of obtained data is presented as the representative value. The transmittance and reflectance of each prototype optical recording medium were measured using a spectrophotometer. The concentration of each element in a thin film was measured using an analyzing method such as induced coupled plasma (ICP), Rutherford backscattering spectroscopy (RBS), secondary ion mass spectroscopy (SIMS), TOF-SIMS, or X-ray photoelectron spectroscopy (XPS). The bond form between elements in a film was analyzed by XPS or infrared (IR) spectroscopy. The thermal conductivity and thermal diffusivity of a thin film and the interface thermal resistance between stacked thin films were evaluated by a thermo-reflectance method.

It is difficult for the conventional write strategy such as a so-called multi-pulse or block strategy used for recording to shorten the rise time of an optical pulse to 0.9 ns or less because a normal semiconductor layer needs to be used without any large improvement. An optical pulse having a rise time of 0.9 ns or less further enhances the effect of the embodiment. A detailed method of generating a waveform or pulse train in which the rise time of an optical pulse used in recording falls within the range of 0.1 to 0.9 ns (inclusive) will be described below.

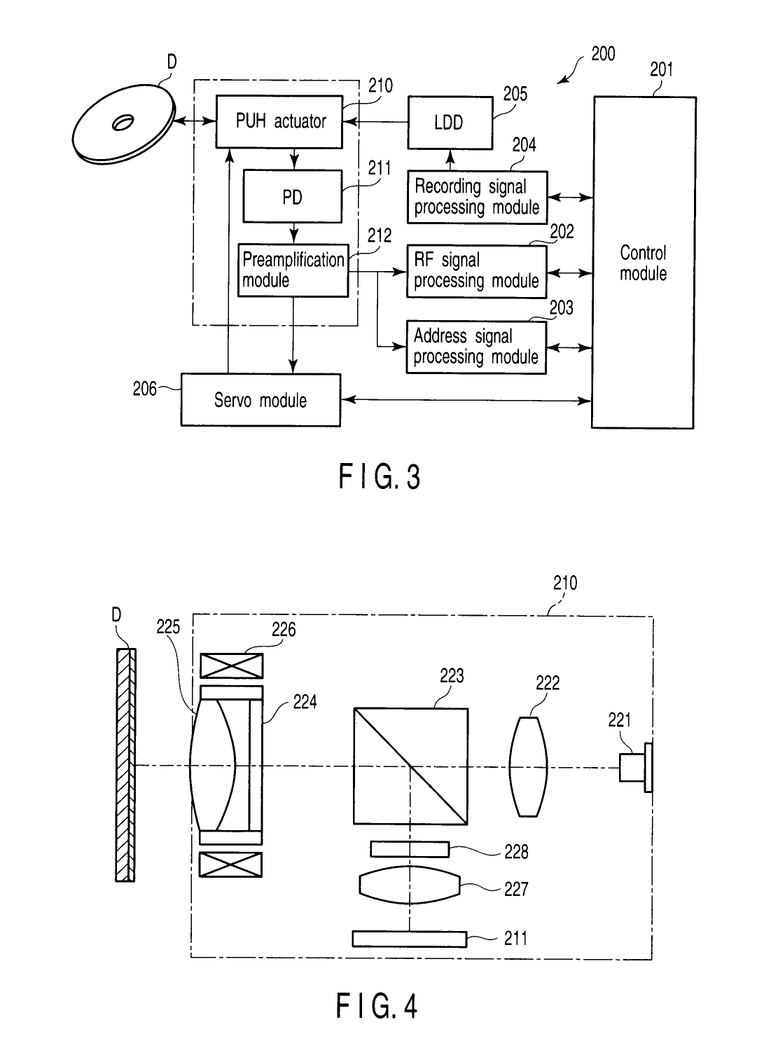

FIG. 3 shows an example of an information recording/playback apparatus (optical disk apparatus) to which the embodiment of the invention is applicable.

The information recording/playback apparatus shown in FIG. 3, i.e., an optical disk apparatus 200 focuses a laser beam emitted from an optical pickup (PUH actuator) 210 to the information recording layer of a recording medium, i.e., an optical disk D, thereby recording information on the optical disk D or playing back information from the optical disk D.

A turntable (not shown) of a disk motor (not shown) supports the optical disk D. When the disk motor rotates at a predetermined rotational speed, the optical disk D also rotates at a predetermined rotational speed.

The PUH (optical pickup) 210 is moved by a pickup feed motor (not shown) in the radial direction of the optical disk D at a predetermined speed in each of information recording, playback, and erase operations.

The PUH 210 incorporates a laser diode (LD) 221 which outputs a laser beam (light beam) having a predetermined wavelength of, e.g., 405 nm, and an objective lens 225 which focuses the light beam output from the laser diode (LD) 221 onto the recording surface of the optical disk D and also captures the light beam reflected by the recording surface (signal surface) of the optical disk D, as will be described below with reference to FIG. 4.

The PUH 210 also incorporates a photodetector (PD) 211 which receives the light beam that is output from the laser diode 221 and reflected by the recording surface of the optical disk D and outputs a current or voltage corresponding to the light intensity, a focusing control coil (not shown) which moves the objective lens 225 in a direction perpendicular to the surface of the optical disk D, and a tracking control coil 226 which moves the objective lens 225 in the radial direction of the optical disk D.

The signal detected by the photodetector 211 is processed by a signal processing module provided at the succeeding stage into a data signal usable for information playback. The output from the photodetector 211 is processed into control signals to locate the objective lens 225 (PUH 210) at a predetermined position with respect to the recording surface of the optical disk D, i.e., a focusing error signal usable for supplying a focusing control signal to the focusing control coil and a tracking error signal usable for supplying a tracking control signal to the tracking control coil 226.

As the optical disk D from which the optical pickup (PUH) 210 of the invention can read a reflected light beam for at least tracking control, for example, an optical disk of a new (next-generation) DVD (to be referred to as an “HD DVD” hereinafter) standard is usable, which allows recording at a higher density than in optical disks of the current DVD standard. Various known kinds of disks are also usable, as a matter of course, including a DVD-RAM disk and a DVD-RW disk which allow information recording and erase based on the current DVD standard, a DVD-R disk capable of only write of new information, and a DVD-ROM disk on which information is already recorded.

The photodetector (PD) 211 of the PUH 210 detects the laser beam reflected by the optical disk D as an electrical signal. The output signal from the PD 211 is amplified by a preamplification module 212 and output to a servo module (lens position control module) 206, RF signal processing module (output signal processing module) 202, and address signal processing module 203 which are connected to a controller 201 (lens position controlled variable setting device [main controller]).

The servo module 206 generates a focusing servo (control of the distance between the objective lens and the information recording layer of the optical disk D with respect to the focusing position of the objective lens) signal and tracking servo (control of the objective lens position in a direction to traverse the tracks of the optical disk D) signal for the objective lens 225 supported by the PUH 210 and outputs the signals to a focusing actuator and tracking actuator (lens position control mechanism) (not shown) of the PUH 210.

The RF signal processing module 202 extracts user data and management information from the signal detected and played back by the PD 211 and outputs them to the controller 201. The address signal processing module 203 extracts, from the detected signal, address information, i.e., information representing a track or sector of the optical disk D, which the objective lens of the PUH 210 is currently facing, and outputs the information to the controller 201.

The controller 201 controls, on the basis of the address information, the position of the PUH 210 to read data such as user data from a desired position or record user data or management information at a desired position.

The controller 201 also designates the intensity of a laser beam to be output from the laser element (LD) for information recording or playback. Note that it is possible to erase data already recorded at the address of a desired position (track or sector) in accordance with an instruction of the controller 201.

To record information on the optical disk, a recording signal processing module 204 supplies, to a laser driving module (LDD) 205, recording data, i.e., a recording signal that is modulated to a recording waveform signal suitable for recording on the optical disk (under the control of the controller 201). In correspondence with the laser driving signal supplied from the LDD 205, the laser element of the PUH 210 outputs a laser beam having an intensity changed according to the information to be recorded. The information is thus recorded on the optical disk D.

FIG. 4 shows an example of the PUH (optical pickup) of the optical disk apparatus shown in FIG. 3.

The PUH 210 includes the LD, i.e., the light source 221 that is, e.g., a semiconductor laser element. The wavelength of the laser beam output from the LD 221 is, e.g., 405 nm.

The laser beam from the LD (light source) 221 is collimated (converted into a parallel beam) by a collimator lens 222. The laser beam then passes through a polarized beam splitter (PBS) 223 and a λ/4 plate (polarized light control element) 224 which are provided at predetermined positions in advance, and is captured by the condenser element, i.e., the objective lens (OL) 225. The objective lens 225 gives predetermined convergence to the captured laser beam (the laser beam from the LD 221 is guided to the objective lens 225 and forms a minimum light spot at the focusing position of the objective lens 225). Note that the objective lens 225 is made of, e.g., plastic, and its numerical aperture NA is, e.g., 0.65. Alternatively, the numerical aperture NA is, e.g., 0.85.

The laser beam reflected by the information recording surface of the optical disk D is captured by the objective lens 225, given an almost parallel sectional beam shape, and returned to the polarized beam splitter 223. Note that the λ/4 plate 224 changes the direction of polarization of the laser beam reflected by the optical disk D by 90° with respect to that of the laser beam directed to the optical disk D.

The reflected laser beam is returned to and reflected by the polarized beam splitter 223 because the λ/4 plate 224 has changed its direction of polarization by 90°. The laser beam then forms an image on the light-receiving surface of the photodetector 211 via a focusing lens 227. Before predetermined convergence is given by the focusing lens 227, the reflected laser beam is divided into a predetermined number of beams via a beam dividing element 228 in correspondence with the array of detection regions given to the photodetector (PD) 211 in advance.

More specifically, the collimator lens 222 collimates the laser beam emitted by the semiconductor laser (LD) 221. The laser beam is linearly polarized light. The laser beam passes through the polarized beam splitter (PBS) 223 and the λ/4 plate 224 which changes (rotates) the plane of polarization to circularly polarized light. Then, the objective lens 225 focuses the laser beam onto the optical disk D.

The laser beam focused on the optical disk D is modulated by recording marks (recording mark sequence) recorded on the optical disk, or grooves.

The reflected laser beam reflected or diffracted by the recording surface of the optical disk D is converted into an almost parallel beam again by the objective lens 225. The laser beam passes through the λ/4 plate 224 again so that the direction of polarization changes by 90° with respect to that of the incident light.

The reflected laser beam whose direction of polarization has thus changed by 90° with respect to that of the incident light is reflected by the polarizing plane of the polarized beam splitter (PBS) 223. The laser beam is divided into a plurality of light beams corresponding to the detection regions given to the photodetector (PD) 211 in advance, and deflected in predetermined directions by the beam dividing element 228 (each divided laser beam changes its distance from the center to a corresponding light-receiving region of the photodetector).

The lens 227 focuses each of the predetermined number of beams obtained by dividing the reflected laser beam to a predetermined light-receiving region of the photodetector 211.

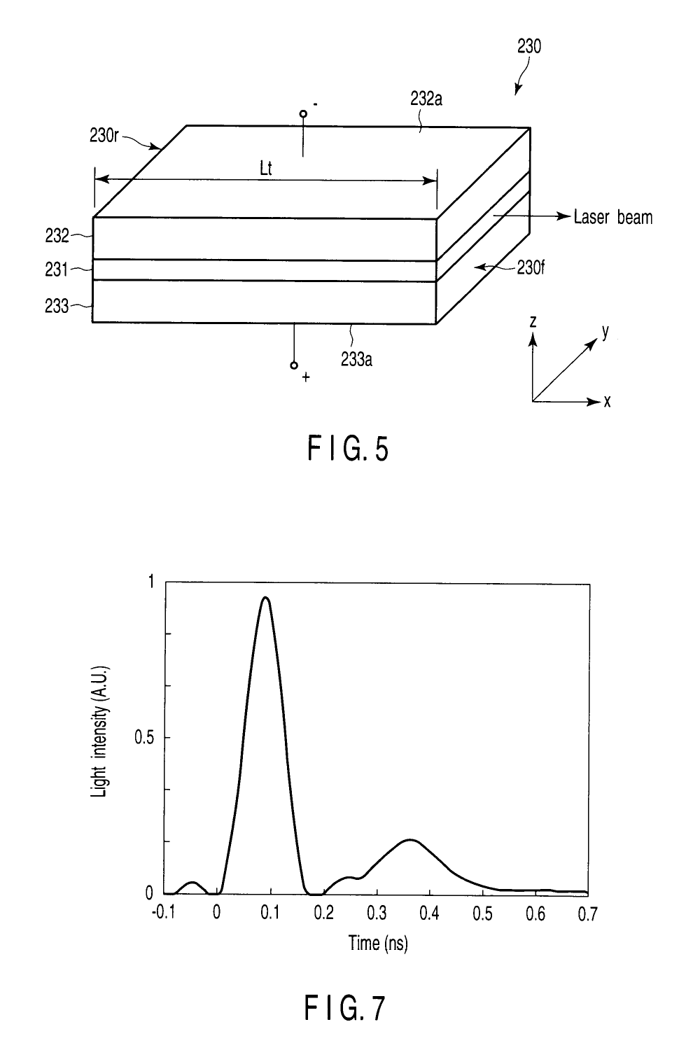

FIG. 5 is a schematic view for explaining the arrangement (cavity length) of the laser diode.

The laser diode (LD) 221 includes, in a housing (not shown), a semiconductor laser chip 230 schematically shown in FIG. 5.

The laser chip 230 is, e.g., a very small block having, e.g., a thickness (vertical direction) t of 0.15 mm, a length (horizontal direction) L of 0.5 mm, and a width (depth direction) d of 0.2 mm.

In the laser chip 230, a first cladding 232 and a second cladding 233 sandwich an active layer 231 in the vertical direction. An upper end 232a and a lower end 233a of the claddings correspond to a “−(negative)” electrode (232a) and a “+(positive)” electrode (233a).

The materials of the first cladding 232 and second cladding 233 are selected such that their refractive index becomes lower by, e.g., about 5% than that of the active layer 231. Light generated in the active layer 231 propagates through it while being reflected by the interfaces to the upper and lower cladding layers. The light is gradually amplified during propagation between mirror surfaces 230f and 230r. When amplified to a predetermined level, the light is emitted from the mirror surfaces 230f and 230r as a laser beam. That is, the laser beam is output in the x direction parallel to the extending direction of the active layer 231 in the example shown in FIG. 5. The distance between the first mirror surface 230f and the second mirror surface 230r is a cavity length Lt.

In the laser chip 230 shown in FIG. 5, a distance L between the first mirror surface 230f and the second mirror surface 230r is defined depending on the pulse length of the required laser beam. In this example, the cavity length Lt is about 0.8 mm. Note that the period of relaxation oscillation to be described later is about 100 ps (picoseconds) in the full width at half maximum.

Upon receiving the driving current from the LDD (laser driving module) 205 shown in FIG. 3, the LD 221 emits (oscillates) the laser beam. Note that the rise time of the driving current supplied from the LDD 205 to the LD 221 is about 1 ns.

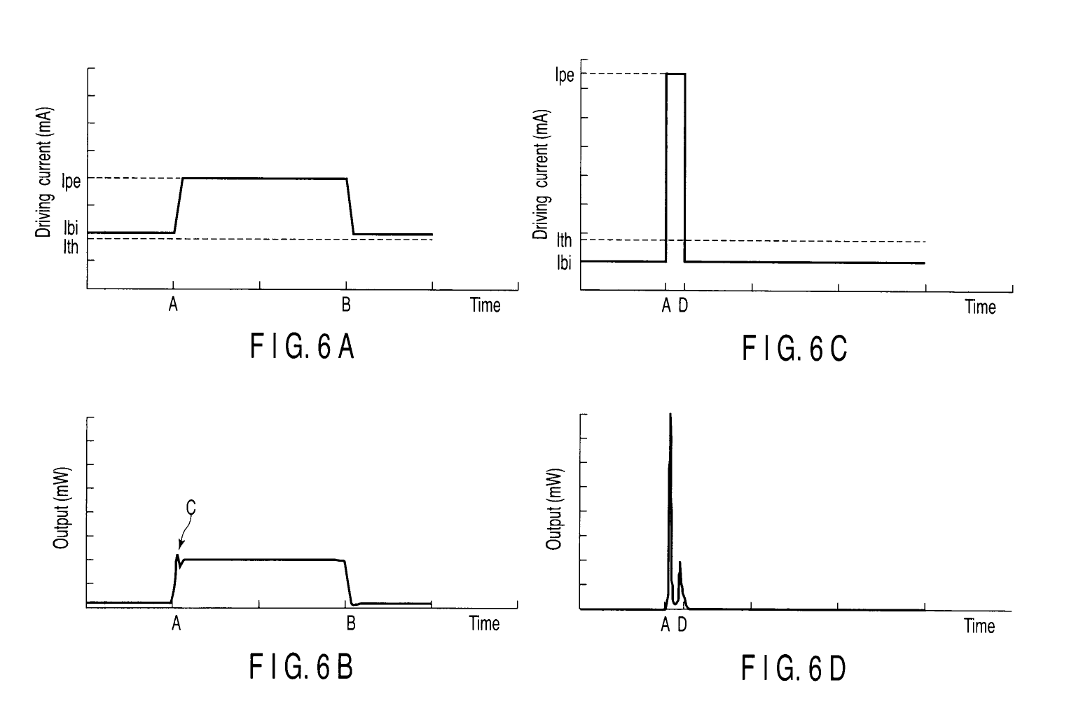

A method (laser driving method) of generating a recording pulse usable to record information in the recording film (not shown) of the recording medium, i.e., the optical disk D will be described next with reference to FIGS. 6A to 6D.

FIGS. 6A and 6B show the general relationship between a laser driving current and laser beam emission (laser output) of a semiconductor laser element upon receiving the laser driving current. FIG. 6C shows an example of supply of a laser driving current capable of obtaining a relaxation oscillation pulse (characteristic laser output). FIG. 6D shows laser output upon receiving the laser driving current.

As shown in FIGS. 6A and 6C, the driving current is controlled to two levels: a bias current Ibi and a peak current Ipe. The bias current is further controlled to two or three levels in some cases. In this example, however, both the bias current and the peak current are controlled to a single level, for the descriptive convenience.

In normal recording pulse generation, as shown in FIG. 6A, the LDD 205 first generates the bias current Ibi set to a level slightly higher than that of a threshold current Ith at which the LD 221 starts laser oscillation, thereby preliminarily driving the LD 221. Then, the LDD applies the peak current Ipe to obtain a desired peak power from a time A to a time B at which the level drops to the bias current Ibi. When the peak current Ipe is applied from the time A to the time B, the laser output (a time-rate change in the laser exit light intensity) shown in FIG. 6B is obtained.

More specifically, when the bias current Ibi is being supplied up to the time A, the intensity of the laser beam output from the LD 221 is so low that no data can be recorded on the optical disk D. When the peak current Ipe is applied, the laser beam intensity rises to the recording power. From the time B, the intensity of the exit light lowers again, as a matter of course.

The exit light intensity will be observed more specifically. In FIG. 6B, the intensity rises to the recording power at the time A. At this time, the intensity instantaneously rises and then lowers before it stabilizes at the steady recording power (a portion indicated by an arrow c in FIG. 6B). This phenomenon occurs due to relaxation oscillation of the LD 221. In normal recording pulse generation, control is done to minimize the relaxation oscillation.

Relaxation oscillation is a transient oscillation phenomenon that occurs when the driving current of a semiconductor laser abruptly rises from a given level to a predetermined level much higher than that of the threshold current.

Note that the relaxation oscillation diminishes as it repeats, and finally stops.

The more preferable optical recording apparatus of the invention positively utilizes the relaxation oscillation.

Fundamentally, the relaxation oscillation should be suppressed. However, the invention aims at “stably” obtaining a steep and short recording pulse by using the unique features of the relaxation oscillation, i.e., “the pulse length is short”, and “the energy amount (the integrated value of the laser power as an optical output) can sometimes change the recording film of the optical disk D to the recording level”.

When the LDD 205 supplies a driving current having a predetermined characteristic to the LD 221, as shown in FIG. 6C, a laser output having a high peak level is obtained in a very short period of time, though it includes oscillation, as shown in FIG. 6D.

More specifically, the bias current Ibi set to a level lower than that of the threshold current Ith is supplied to the LD 221. At a predetermined timing, i.e., the time A, the driving current is raised to the peak current level Ipe higher than the level of the threshold current Ith abruptly in a shorter rise time than in normal recording pulse generation. At a time D after the elapse of a shorter time of the nanosecond order than in normal recording pulse generation, the driving current is returned to the bias current Ibi.

In this case, a laser output (a time-rate change in the laser exit light intensity) is obtained, as shown in FIG. 6D.

More specifically, until the time A in FIG. 6D, the LD 221 is driven by the bias current Ibi at a lower level than that of the threshold current Ith and therefore does not start laser oscillation. The light-emitting diode only emits light of negligible level. When a current is abruptly applied at the time A, relaxation oscillation occurs, and the exit light intensity also rises abruptly.

The amplitude of the relaxation oscillation gradually converges to the steady level. When the driving current is set to Ibi at the level lower than that of the threshold current Ith at a predetermined time, i.e., a time C, a laser beam having a certain energy amount is obtained. The time C is the timing when the pulse of the second period of the relaxation oscillation is generated, as is apparent from FIGS. 6C and 6D.

As a characteristic feature of the pulse generated by the relaxation oscillation, the exit light intensity rises in a much shorter time than a normal recording pulse and then lowers at a predetermined period determined by the structure of the semiconductor laser. Hence, when the pulse generated by the relaxation oscillation is used as a recording pulse, it is possible to obtain a short pulse having a short rise/fall time and a high peak intensity, which cannot be obtained in a normal recording pulse.

The period of relaxation oscillation is known to be relevant to the cavity length of the laser chip of the semiconductor laser element (LD) described with reference to FIG. 5.

The cavity length L of the LD and a relaxation oscillation period T have a generally known relationship given by

T=k x[2 nL/c] (1)

where k is a constant,

n is the refractive index of the active layer of the semiconductor laser, and

c is the velocity of light (3.0×10⁸ m/s)

Hence, the thickness of the laser chip, the relaxation oscillation period, and the pulse width of the steep pulse generated by the relaxation oscillation have a proportional relationship. To increase the relaxation oscillation pulse width, the cavity length is increased. To decrease the relaxation oscillation pulse width, the cavity length is decreased.

A method of arbitrarily setting the pulse width of the relaxation oscillation pulse generated by relaxation oscillation by controlling the cavity length of the laser chip will briefly be described below.

FIG. 7 shows the measurement result of a relaxation oscillation waveform generated by a semiconductor laser with a cavity length of 650 μm.

As is apparent, a relaxation oscillation pulse width (FWHM) Wr is about 81 ps (picoseconds) in the full width at half maximum.

The cavity length of the laser chip 230 of the LD 221 and the relaxation oscillation pulse width have a proportional relationship, as described above. For this reason, a relationship given by

Wr(ps)=L(μm)/8.0 (μm/ps) (2)

is obtained as the transformation of the cavity length Lt of the laser chip 230 and the obtained relaxation oscillation pulse width (FWHM) Wr.

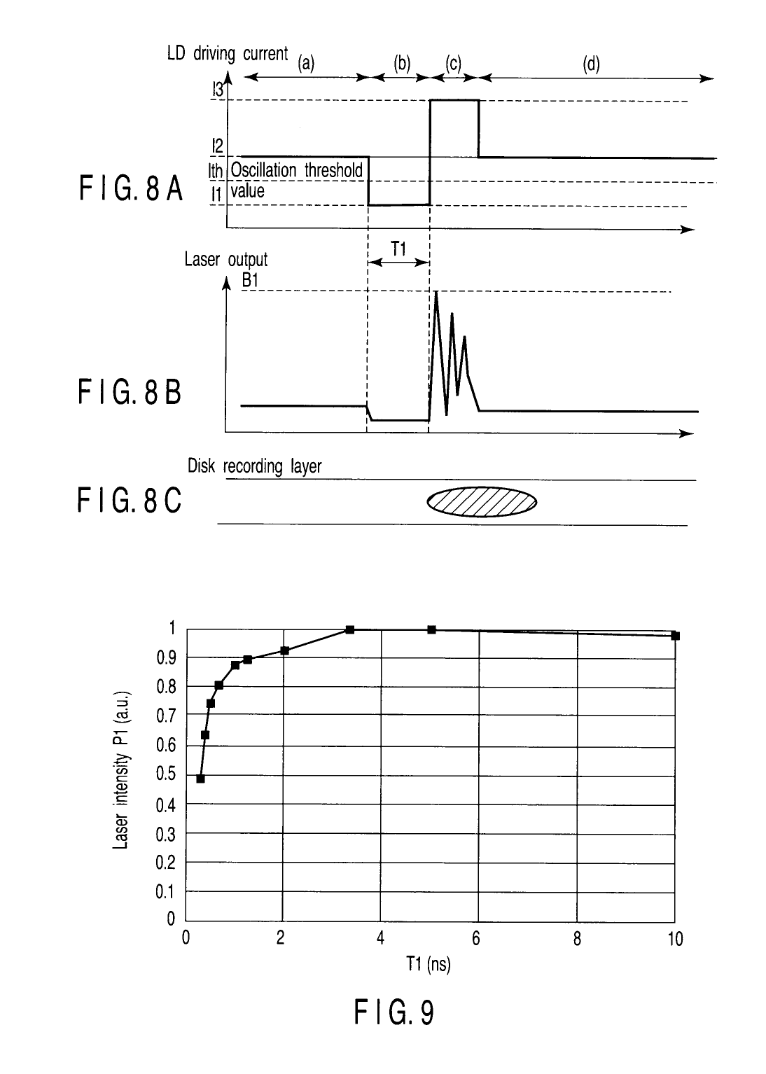

FIG. 8A shows the time evolution of the laser driving current supplied from the LDD (laser driving module) to the LD (laser element). FIG. 8B shows the laser waveform output from the LD. FIG. 8C shows the shape of a mark (recording mark) formed on the recording film of the optical disk D by the output laser waveform.

Referring to FIG. 8A, in a range (a) in which the focusing point of the laser beam on the recording film of the optical disk D exists in a place where no recording mark is formed, the power of the laser beam emitted from the LD 221 is controlled to a playback power which is used to read position information on the optical disk D and play back information from the optical disk D for servo control. That is, a driving current I2 greater than the threshold value Ith of the laser-oscillable driving current is supplied to the LD 221.

In a range (c), a laser driving current I3 greater than I2 is supplied to the LD 221 so that a relaxation oscillation laser beam (FIG. 8B) whose maximum value is P1 is output.

During a predetermined time T1, i.e., in a range (b) immediately before the range (c) where the relaxation oscillation pulse beam is output, a laser driving current I1 smaller than the threshold value Ith is supplied to the LD 221.

In a range (d) after the end of the relaxation oscillation, the above-described laser driving current I2 greater than the threshold value Ith is supplied again.

That is, in the invention which records information on the optical disk D using a steep pulse laser obtained by relaxation oscillation, the time average power of the laser beam emitted for recording is smaller than the laser power (playback power) necessary for playing back information recorded on the optical disk D. If recording should start immediately after information playback from the optical disk D, the average laser power to be output from the laser is varied.

When the average laser power varies, the temperature of the LD 221 changes, and the threshold current of the LD 221 also varies.

Even when the same current is supplied to the LD 221, the laser intensity is changed before and after the temperature change. Hence, such a variation in the threshold value is preferably avoided to record a satisfactory recording mark on the recording film of the optical disk D.

To solve this problem, the average laser power in playback is preferably almost equal to that in recording. As is confirmed, the average laser power in recording and that in playback, and for example, a first average power (A) used in playback and a second average power (B) used in recording allow to almost neglect the influence of the temperature change within the range represented by

0.8<A/B<1.2

FIG. 9 shows the relationship between the maximum strength P1 of relaxation oscillation and the time T1 during which the driving current value supplied to the LD (laser element) is set to I1. The LD has a wavelength of 405 nm, a cavity length of 800 μm, and a laser oscillation threshold value of 35 mA and supplies the driving current abruptly from 20 mA to 120 mA in a rise time of 150 ps.

As already described, relaxation oscillation is a transient oscillation phenomenon that occurs when the driving current of a semiconductor laser (oscillation system) abruptly rises from a given level to a predetermined level much higher than that of the threshold current. To use this as a recording pulse, the pulse width (recording pulse length) needs to be stable. When the time T1 is short, the maximum power P1 of the laser beam generated by the relaxation oscillation is low. As T1 becomes long, P1 also increases to about 2.2 times the steady oscillation power. After that, P1 converges. After convergence of relaxation oscillation, the laser intensity is 0.45×P1.

It is known that when the peak power P1 at the start of relaxation oscillation is high, the total recording energy is smaller than in recording using steady power oscillation. In the method of recording a recording mark on the optical disk by thermal recording (the thermal energy amount supplied as the laser beam), the thermal diffusion time is as short as about 1 ns, as compared to a normal method of recording a mark by long-time irradiation of a low-power laser beam. In the normal method of recording a mark in a longer time, thermal diffusion occurs even during laser irradiation. In the method using relaxation oscillation, however, since the optical disk is irradiated with the high-power laser beam in a short time of 1 ns or less, thermal diffusion is minimum during laser irradiation. For this reason, the recording energy as the time-integrated value of power is smaller in the recording method using relaxation oscillation than in the recording method using laser irradiation for 1 ns or more. When the relaxation oscillation peak power P1 at the start is 2.2 times the normal steady laser intensity, the recording energy decreases to about 40% of that of the normal steady oscillation laser. This also reduces the energy consumption of the pickup head and suppresses the increase in its temperature. An optical element such as an objective lens or a mirror in the pickup head causes thermal expansion and deforms as the temperature rises, resulting in an increase in the diameter of a spot focused by the objective lens and an increase in the size of a recorded mark. However, recording using relaxation oscillation can suppress the increase in the temperature and solve the problem.

Especially, when P1 is more than twice the steady laser power, the effect of reducing the recording energy is conspicuous as compared to normal steady laser irradiation. Hence, to record a mark using relaxation oscillation, the time T1 is preferably 1 ns or more, in which P1 is 90% of the saturation value.

If T1 is 3 ns or more, P1 almost equals the saturation power. It is also confirmed that a longer time rarely influences the laser output. Hence, T1 is more preferably 3 ns or more.

A rise time Tr and a fall time Tf of the current supplied from the LDD 205 to the LD 221 (times necessary for the current for varying from 10% to 90% of the maximum current flowing to the LD 221) are 150 ps each when all the capacitances and coefficients of induction of wirings (not shown) in the LD 221 and LDD 205 and from the LDD 205 to the LD 221 are taken into consideration.

If the fall time Tf is long, the time after a current value equal to or smaller than the threshold value is set for the LDD 205 until the value of the current actually flowing to the LD 221 becomes equal to or smaller than the threshold value is long. This time almost equals the fall time Tf. Hence, to generate relaxation oscillation of an appropriate magnitude, an interval T corresponding to (Tf+0.85) ns or more is preferably prepared. That is, if Tf is 150 ps, T1 is preferably 1,000 ps or more.

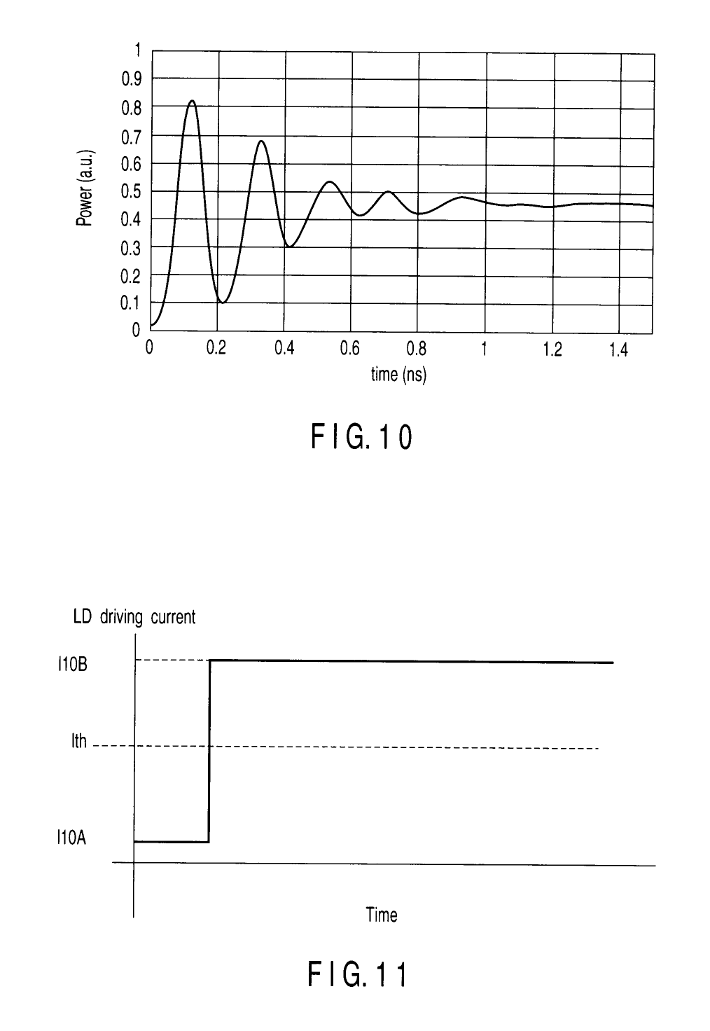

FIG. 10 shows the waveform of a laser output from the LD which has received a driving current shown in FIG. 11. The current is supplied in the following way. A current I10A smaller than the laser oscillation threshold value Ith is supplied. After that, a current I10B equal to or greater than the threshold value is abruptly supplied to the LD, and the current is maintained from then. In this case, the laser waveform shown in FIG. 10 is obtained. That is, after relaxation oscillation occurs four or five times during a predetermined time, steady output of laser oscillation is obtained.

As shown in FIG. 10, when the cavity length of the laser chip 230 of the LD 221 is 800 μm, and the peak power P1 is “1”, the laser intensity converges to 0.45×P1 in about 1 ns (or 1.5 ns even if the range shown in FIG. 10 is defined as relaxation oscillation). Note that the number of times of relaxation oscillation until convergence does not depend on the cavity length of the LD. On the other hand, the period of relaxation oscillation is proportional to the cavity length, as described above. For this reason, the time until convergence of relaxation oscillation with respect to the cavity length Lt [μm] is Lt/800 [ns]. In recording using relaxation oscillation, if the steady power laser output without relaxation oscillation is long, the quality of marks degrades. If a disk is irradiated with a laser during relaxation oscillation, the temperature rise in the recording layer is greater than when irradiated with a laser in the steady state. For this reason, a mark recorded during relaxation oscillation of the laser is wider than that recorded in the steady state of the laser. This makes the mark widths uneven and degrades the quality of marks. To prevent this, the recording pulse width is preferably less than the time in which the relaxation oscillation converges to the steady state.

Hence, when the cavity length is 800 μm, the recording pulse length, i.e., the length of the range (c) in FIG. 8A need only be shorter than 1,500 ps (1.5 ns).

As described above, in recording using relaxation oscillation, the width of the steep recording laser pulse induced by relaxation oscillation is as short as 1.5 ns, as compared to the laser output obtained by general driving current supply. Hence, a laser beam with a large peak output P1 is emitted.

In an optical disk on which a recording mark is recorded by thermal recording (the thermal energy amount supplied as a laser beam), the recording method using relaxation oscillation can reduce the recording energy as compared to the normal method of recording a mark by long-time irradiation of a low-power laser beam.

More specifically, when the recording pulse obtained by relaxation oscillation is used, the time of laser beam irradiation on the recording film of the optical disk D is shorter than in recording using a laser beam without relaxation oscillation. Hence, the heat amount diffused from the laser irradiation place of the recording layer of the optical disk to other places decreases.

This indicates that the average laser power required of the recording pulse can also be made lower than in the conventional recording method.

In “sub-nano-pulse recording” explained based on FIGS. 3 to 11, the laser beam emission time with respect to the length of each mark of the recording mark sequence recorded on the optical disk (information recording medium) is 10% or less (1% to 10%). Hence, the average power value of the laser beam in recording is sometimes smaller than that in playback.

On the other hand, some optical disks serving as a recording medium have a small reflectance difference between the mark portion and the space portion because of the materials. To improve the apparent contrast, a recording medium has been developed which reduces the reflectance of the mark portion or space portion to about 2% when information has been recorded.

When the recording method using a sub-nano pulse is applied to information recording on such a recording medium, the average light amount returned to the photodetector in the optical head during recording is very small. This may considerably degrade the quality of the detected signal and disable the operation of obtaining an error signal from the detected signal and keeping the objective lens at a predetermined position of the recording layer (focusing/tracking servo).

The present inventor has already proposed the optical disk apparatus shown in FIG. 3 as an information recording/playback apparatus capable of normally executing focusing/tracking servo while performing recording using a sub-nano pulse by superimposing a high-frequency signal between recording pulses to increase the average light amount.

However, in generating a recording pulse using a sub-nano pulse while superimposing a high-frequency signal between the recording pulses, if the difference between the potential (or current) level of the edge of the recording pulse and the potential (or current) level of the high-frequency signal following the recording pulse is large, unnecessary (unwanted) relaxation oscillation may occur in the LD (laser element) 221. The unnecessary relaxation oscillation causes variations in the laser beam and disturbs the recording marks and playback signal.

The high-frequency signal is superimposed between the recording pulses without causing the unnecessary relaxation oscillation.

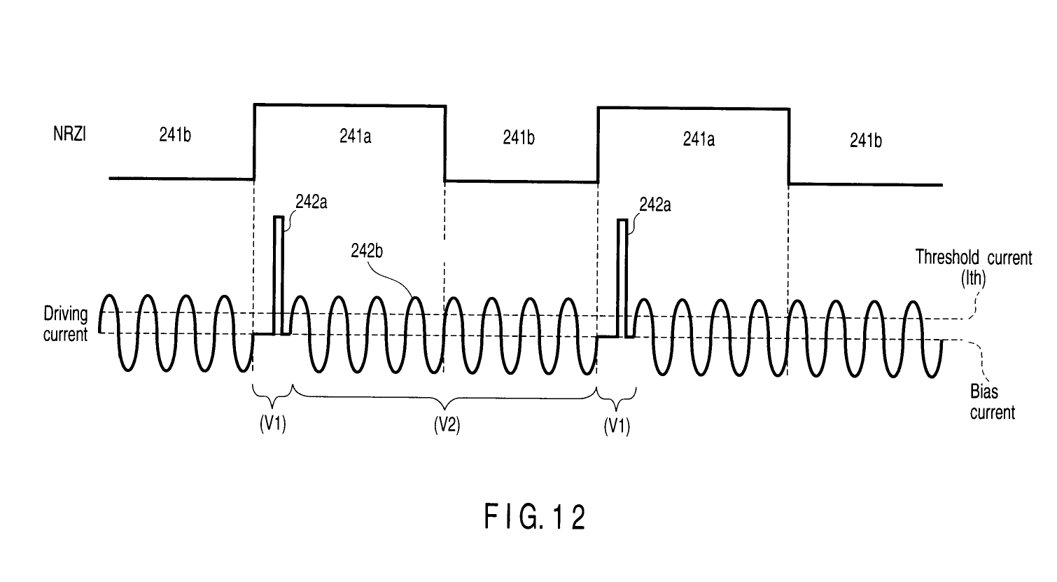

FIG. 12 shows an example. When recording data (NRZI) and a corresponding driving current waveform of the laser diode (LD) include a recording pulse period (V1) and a high-frequency signal superimposition period (V2), a recording pulse 242a is output once or a plurality of number of times in a mark portion 241a. Outside the recording pulse period (V1), a high-frequency signal 242b is output independently of the mark portion 241a and a space portion 241b. This maintains the average light intensity of the laser diode.

The driving current during the recording pulse period (V1) makes the LD 221 emit light with a higher intensity during the recording pulse period (V1) than during the high-frequency signal superimposition period (V2). This strong light emission causes a thermal change in the recording layer of the optical disk to form a recording mark. The driving current during the high-frequency signal superimposition period (V2) has such a current value that the average light intensity of the laser diode causes no thermal or optical change in the recording layer of the optical disk.

In many cases, this is the light intensity when reading information from the recording layer of the optical disk. The threshold current level shown in FIG. 12 determines whether to cause the laser diode to start or stop light emission. To obtain relaxation oscillation, the laser diode requires a recording pulse which steeply changes from a level below the threshold current level. Hence, to record information, it is necessary to temporarily lower the current level from the current value for obtaining the light intensity for information read from the recording layer of the optical disk to a level lower than the threshold current level and then obtain the steeply changing recording pulse 242a. In the recording mode, the light intensity for information read from the optical disk is necessary for reading an address and the like. Note that a period in which the driving current is set at a predetermined bias current may be provided between the recording pulse 242a and the high-frequency signal 242b.

As described above, in recording using a sub-nano pulse, a state called relaxation oscillation is generated in the laser diode to obtain light having a high light emission intensity. Hence, even after the driving current is stopped after the recording pulse 242a, light emission continues while the light emission intensity attenuates. When a bias period with a constant driving current is provided after the recording pulse 242a until relaxation oscillation converges, stable recording can be performed. It will easily be understood that the recording pulse 242a can be obtained by adding a high frequency superimposing module (not shown) capable of outputting the high-frequency signal 242b to the laser driving module (LDD) 205 shown in FIG. 3.

FIG. 12 shows only one kind of relationship between the NRZI waveform and the driving current of the laser diode for the descriptive convenience. However, various kinds of NRZI waveforms are used in accordance with channel data. Additionally, recording pulses for effectively forming mark portions and space portions on the recording medium are generated in accordance with the NRZI waveform. This method stabilizes the pulse width of the laser beam of sub-nano class generated by relaxation oscillation, i.e., the recording pulse length. This allows to improve the recording density. The same effect was obtained even in the following examples.

### EXAMPLE 1

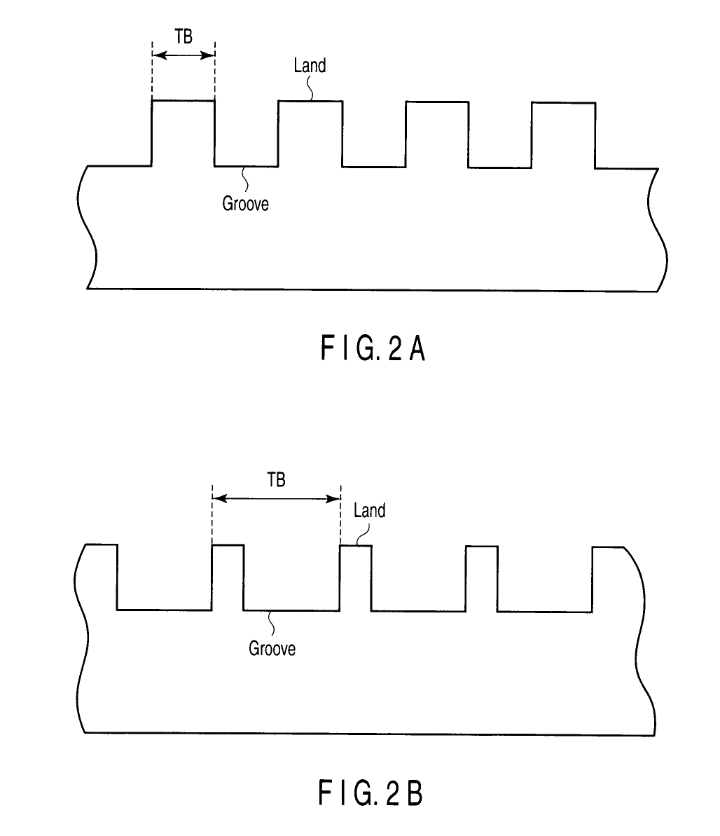

The optical recording medium will be described again with reference to FIGS. 1A and 1B. The recording methods are classified into a method of recording information in both lands (L) and grooves (G) (land/groove recording) and a method of recording information in only groves or lands (so-called groove recording). The optical pickup in the recording/reading system of the optical recording/playback apparatus uses a lens having an NA of 0.65 or a lens having an NA of 0.85. In this example to be described below, the former method was used. As the substrate, a 0.6- or 0.59-mm-thick polycarbonate (PC) substrate formed by injection molding was used. In the land/groove recording method, grooves were formed at a groove pitch of 0.6 to 0.68 μm. That is, TP×NA/λ ranged from 0.481 to 0.546. The widths of the grooves and lands were almost uniform, and TB=0.3 to 0.34 μm. The definition of TB is shown in FIGS. 2A and 2B. In land/groove recording, the track width is defined as TB. In groove recording, the track pitch width is defined as TB.

As the media, examples of single-sided single-layer media and single-sided double-layer media will be described, although the invention is also applicable to a multilayer medium including three or more layers on a single side. In a single-sided single-layer medium, an information layer was formed by sequentially forming ZnS:SiO₂, interface layer, recording film layer, interface layer, ZnS:SiO₂, and Ag alloy on the PC substrate surface with grooves using a sputtering apparatus. In a single-sided double-layer medium, an information layer L0 close to the light incident side was formed by sequentially forming ZnS:SiO₂, interface layer, recording film layer, interface layer, ZnS:SiO₂, Ag alloy, and ZnS:SiO₂. Additionally, an information layer L1 far from the light incident side was formed by sequentially forming an Ag alloy, ZnS:SiO₂, interface layer, recording film layer, interface layer, and ZnS:SiO₂ on the PC substrate. As systems having a smaller number of films, a single-layer medium in which ZnS:SiO₂, recording film layer, ZnS:SiO₂, and Ag alloy were sequentially formed, and a single-sided double-layer medium in which L0 was formed by forming ZnS:SiO₂, recording film layer, ZnS:SiO₂, Ag alloy, and ZnS:SiO₂, and L1 was formed by sequentially forming an Ag alloy, ZnS:SiO₂, recording film layer, and ZnS:SiO₂ on the PC substrate were also prepared. A medium in which ZnS:SiO₂, SiO₂, ZnS:SiO₂, recording film layer, ZnS:SiO₂, and Ag alloy were sequentially formed, and media including an interface layer inserted between the recording film and one or each of the dielectric films were also prepared as single-layer media.

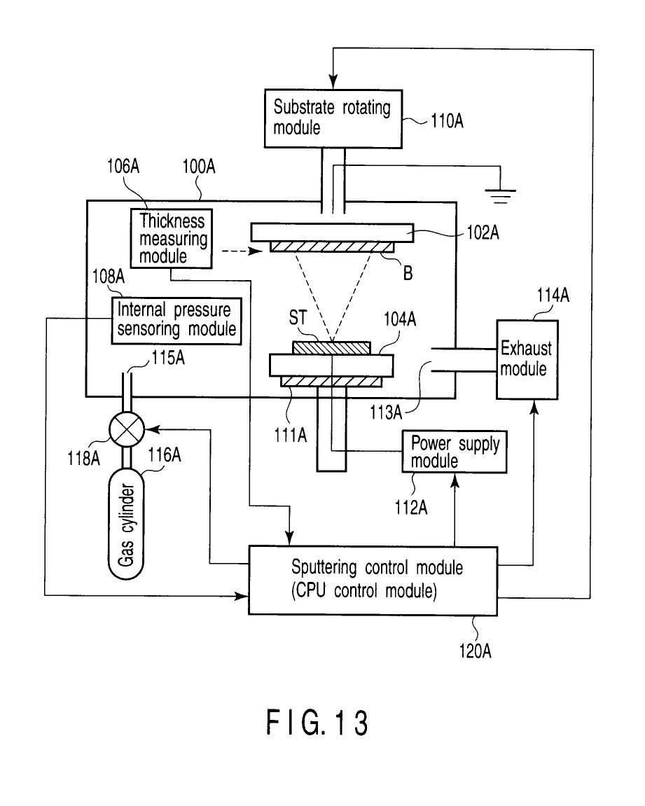

The sputtering apparatus of this embodiment is a so-called single-wafer type sputtering film forming apparatus for forming layers in different film forming chambers by sputtering. The single substrate type sputtering film forming apparatus includes a load lock chamber where a substrate is loaded, a transfer chamber, and process chambers where films are formed. FIG. 13 is a view showing the arrangement of one process chamber.

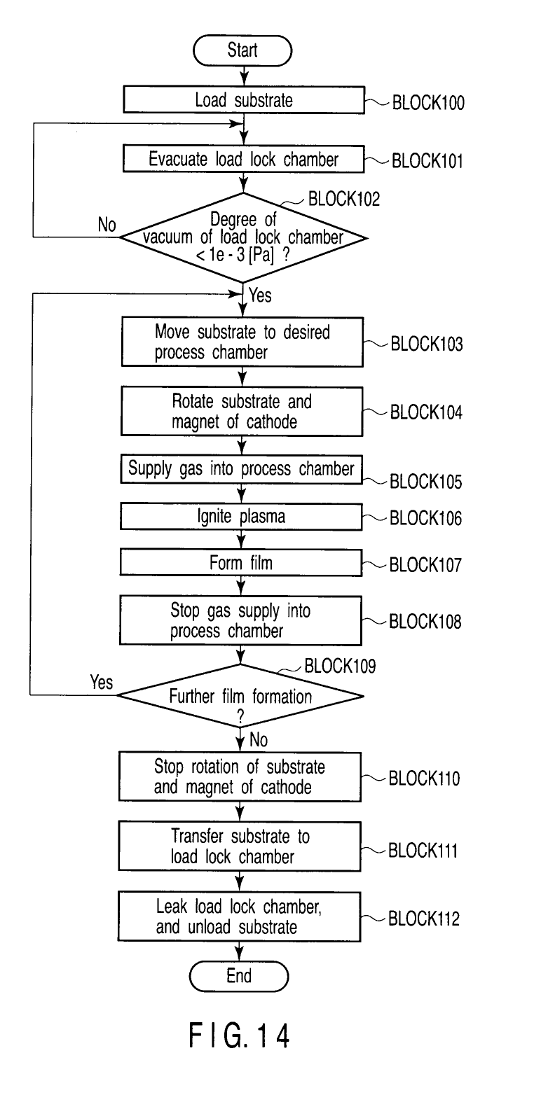

The process chamber forms a film using a sputtering target material ST and a substrate B. The process chamber comprises a cathode plate 102A, anode plate 104A, thickness measuring module 106A, internal pressure sensing module 108A, substrate rotating module 110A, magnet 111A, power supply module 112A, exhaust module 114A, gas cylinder 116A, and sputtering control module 120A. The exhaust module 114A exhausts air from the chamber. An inert gas such as Ar is mainly used as sputtering gas. Oxygen or nitrogen gas is also used as needed. For discharge in sputtering, an RF power supply or DC power supply is used in accordance with a film formation material or properties required of a film. FIG. 14 illustrates the process sequence of film formation.

Film formation is done in accordance with the following procedure.

BLOCK100: A substrate is loaded.

BLOCK101: The load lock chamber is evacuated.

BLOCK102: If the degree of vacuum satisfies the condition, the process advances to the next step.

BLOCK103: The substrate is moved to a desired process chamber.

BLOCK104: The substrate and the magnet of the cathode are rotated.

BLOCK105: The gas is supplied into the process chamber.

BLOCK106: The plasma is ignited.

BLOCK107: A film is formed.

BLOCK108: Gas supply into the process chamber is stopped.

BLOCK109: Is the film formation process is to be continued, the process advances to BLOCK104. Otherwise, the process advances to the next step.

BLOCK110: Rotation of the substrate and the magnet of the cathode is stopped.

BLOCK111: The substrate is transferred to the load lock chamber.

BLOCK112: The load lock chamber is leaked, and the substrate is unloaded.

As will be described later in detail, the recording film layer was made of a material which contains Ge, Sb, and Te in a composition represented by GeₓSb_{y}Te_{z} (x+y+z=100) and is selected from a region defined by x=55/z=45, x=45/z=55, x=10/y=28/z=42, and x=10/y=36/z=54 on the GeSbTe ternary phase diagram, one of GeSnSbTe, GeSnSbTeIn, GeSbTeIn, GeSbTeBiIn, GeSbSnTeBiIn, GeSbTeBi, GeSnSbTeBi, and GeSnSbTeBiIn which are obtained by partially substituting the composition of the above recording film with bismuth (Bi) and/or indium (In) and/or tin (Sn) so that the composition after substitution is represented by (Ge_{(1-w)}Sn_{w})ₓ(Sb₍₁₋ᵥ₎(Bi₍₁₋ᵤ₎Inᵤ)ᵥ)_{y}Te_{z} (x+y+z=100), and w, v, and u of the composition satisfy 0≦w<0.5, 0<v<1, and 0≦u≦0.7, or a material which contains Ge, Bi, and Te in a composition represented by GeₓBi_{y}Te_{z} (x+y+z=100) and is selected from a region defined by x=55/z=45, x=45/z=55, x=10/y=28/z=42, and x=10/y=36/z=54 on the GeBiTe ternary phase diagram. Many compositions were examined. Table 4 shows some examples. The film thickness of the recording film was 10 nm or less.

The interface layer was selected from various materials, as will be described later. An example is ZrO₂+Cr₂O₃. The interface layer was formed using a target containing ZrO₂ mixed with Cr₂O₃. The ZnS:SiO₂ film was formed using a target containing SiO₂ mixed with ZnS. A so-called single-wafer type sputtering film forming apparatus for forming layers in different film forming chambers by sputtering was used as the sputtering apparatus. After formation of each medium, the reflectance and transmittance were measured using a spectrophotometer.

An initializing apparatus crystallized the recording film on the entire surface of each medium. After initialization, the layers were bonded via a UV resin while placing the film formation surfaces inside, thereby forming an interlayer separation layer. The interlayer separation layer was 20 μm thick. Evaluation was done using a disk evaluation apparatus ODU-1000 available from Pulstec Industrial. An apparatus having a blue-violet semiconductor laser with a wavelength of 405 nm and an objective lens with NA=0.65 was prepared. Recording experiments were conducted by the land/groove recording method.

The recording characteristic evaluation experiments for disk were done mainly for the following two evaluations.

(1) Bit Error Rate (Simulated Bit Error Rate [SbER]) Measurement

One of the evaluations is bit error rate (simulated bit error rate [SbER]) measurement for measuring the data error rate. The other is analog measurement for determining the read signal quality with monotone mark. In the SbER measurement, first, a mark sequence including patterns 2T to 13T at random was overwritten 10 times on a track. Next, the same random pattern was overwritten 10 times on adjacent tracks on both sides of the above track. Then, the position was returned to the track in the middle, and SbER was measured.

In recent years, a phase-change recording medium is also used as a write-once medium. No rewrite characteristic is required of a write-once medium. It is the write-once characteristic that is important. The write-once characteristic was also evaluated assuming that the medium of the invention is used as a write-once medium. In this case, a mark sequence including patterns 2T to 13T at random was recorded once on a track. Next, the same random pattern was recorded on adjacent tracks on both sides of the above track. Then, the position was returned to the track recorded first, and SbER was measured.

(2) Analog Measurement

Analog measurement was done in the following way. Similarly, a mark sequence including patterns 2T to 13T at random was overwritten 10 times on a track. Next, a single pattern 9T was overwritten once on the mark sequence. The signal-to-noise ratio (to be referred to as CNR hereinafter) of the signal frequency of the 9T mark was measured using a spectrum analyzer. The disk was irradiated with a laser beam of erase power level for one revolution to erase the recorded marks. The decrease amount of the signal strength of the 9T mark at that time was measured and defined as an erase rate (ER).

A linear velocity v in each evaluation was v=4.7 to 5.6 m/s that is a condition for a so-called uniform speed 1×. Evaluations were done also by setting the rise time of the LD to 0.9 ns or less or 0.1 ns or more. These rise times are very difficult to obtain in the normal light emission mode of the conventional LD. The present inventors realized using a so-called relaxation oscillation mode. For long marks except for short marks such as 2T and 3T, a multi-pulse is usable, as in the prior art. To achieve a high-speed recording medium, a multi-pulse with a 2T period or a so-called block strategy is used. In all the following examples, the above-described conditions were commonly used. In the following example, the worst data of the above evaluation results are presented.

In all the following examples, the above-described conditions were commonly used. Table 1 shows the main recording film materials of the evaluated prototype media.

TABLE 1

| | Composition of |
|---|---|
| No. | recording film |
| 1 | Ge10Sb2Te13 |
| 2 | Ge4Sb2Te7 |
| 3 | Ge8Sb2Te13Bi2 |
| 4 | Ge3Sb2Te7Bi |
| 5 | Ge6Sb2Te13Sn4 |
| 6 | Ge3Sb2Te7Sn |
| 7 | Ge10Bi2Te13 |
| 8 | Ge2.9BiTe4.4 |
| 9 | Ge11.25BiTe12.75 |
| 10 | Ge10Sb1.5In0.5Te13 |
| 11 | Ge10Bi1.5In0.5Te13 |
| 12 | Ge4Sb1.5In0.5Te7 |
| 13 | Ge2.9Bi0.75In0.25Te4.4 |
| 14 | Sb78Te22 |
| 15 | Sb65Te35 |
| 16 | Ga30Sb70 |
| 17 | Ga12Sb88 |
| 18 | In30Sb70 |
| 19 | In20Sb80 |
| 20 | Ge30Sb70 |
| 21 | Ge10Sb90 |
| 22 | Ga9InSb10 |
| 23 | GaIn9Sb10 |

The compositions between the respective compositions were also examined.

For all examples of the recording film, structures including no interface layer were also examined. On the other hand, for the recording films Nos. 1 to 13, structures using one of GeN, GeCrN, ZrSiO₄, ZrO₂+Cr₂O₃, and ZrO₂₋ₓNₓ+Cr₂O₃ as the interface layer were examined. For the recording films Nos. 14 to 23, structures using one of GeN, GeCrN, SiN, and SiC as the interface layer were examined.

As shown in Table 2, in all samples of rewritable recording media, SbER was on the order of 10⁻⁵ or less in both a land and a groove track. That is, a practical error rate was obtained. For analog data, CNR was 52 dB or more in both a land and a groove track. As for the write-once characteristic, SbER was on the order of 10⁻⁸. That is, a very satisfactory result was obtained.

TABLE 2

| | | | | | SbER |
|---|---|---|---|---|---|
| TB | TP × NA/λ | SbER | CNR [dB] | ER [dB] | (write-once) |
| 0.3 | 0.481 | 2.3 × 10⁻⁵ | 52.9 | 34.9 | 2.6 × 10⁻⁸ |
| 0.31 | 0.498 | 2.2 × 10⁻⁵ | 52.6 | 34.8 | 2.0 × 10⁻⁸ |
| 0.32 | 0.514 | 2.2 × 10⁻⁵ | 52.8 | 30.9 | 1.9 × 10⁻⁸ |
| 0.339 | 0.544 | 1.5 × 10⁻⁶ | 53.7 | 34.6 | 1.4 × 10⁻⁸ |

As described in this example, recording can be performed even when TB is small. If TB is small, the problems of crosstalk (XT) and cross-erase (XE) arise. In this example, however, they posed no problem. Note that TB is sometimes called a track pitch (TP). Even at TP=0.34 μm, XT and XE can occur in the context of the beam system and ratio. However, neither XT nor XE occurs at TP smaller than 0.34 μm because of the characteristic features of the medium, information playback apparatus, and information playback method of the embodiment. The characteristics are further improved by shortening the rise time of the laser irradiation beam to be used. The pulse width of whole relaxation oscillation includes a number of pulse trains, as described above. A portion with a low light intensity is not supposed to contribute to recording. Especially, why XE is suppressed small is an important part of the embodiment, and the reason was searched. Of various kinds of examinations, examination using thermal analysis that is relatively easy to understand will be described here. As the thermal analysis, one of so-called unsteady analysis was executed using a three-dimensional finite element method (FEM) numerically. More specifically, the time dependence of laser irradiation and medium temperature change was analyzed by the unsteady analysis. The thermophysical properties were measured by a thermo-reflectance method using samples each having a thickness of the order of 10 nm in consideration of interface thermal resistances. In the prior art, it is impossible to measure samples having a thickness of the order of 10 nm or their interface thermal resistances. The analysis to be described below is therefore expected to ensure an analysis accuracy more than before and more accurately reproduce the actual phenomenon. Whether or not XE occurs was determined based on whether a track nearest to a recorded track is heated to the recording film crystallization temperature (Tc) or more. In a very short time, the recording film is not always crystallized even when it is heated to Tc or more. In the analysis here, however, the determination was done under relatively strict conditions, as described above. Table 3 shows an example of the relationship between TB and the temperature of a track nearest to a recorded track. In this example, the recording film has Tc=190° C., and a melting point Tm=630° C. Hence, if the temperature of the track nearest to the recorded track is lower than the crystallization temperature To, it is estimated that no XE should occur. The NA is 0.65, the substrate thickness on the light incident side is 0.6 mm, and v=5.6 m/s. Table 3 shows an example of L0 of a single-sided double-layer medium. A comparative example is also shown, in which the rise time of the laser was 1 ns. As an example of the embodiment, a pulse generated by relaxation oscillation was used. In the comparative example, recording was performed using a laser pulse with a rise time of 1 ns or more, as in the prior art.

TABLE 3

Temperature of nearest
track [° C.]

| | | Examples of | Comparative |
|---|---|---|---|
| TB [μm] | TP × NA/λ | invention | examples |
| 0.34 | 0.546 | 150 | 160 |
| 0.32 | 0.514 | 172 | 183 |
| 0.3 | 0.481 | 177 | 200 |

As is apparent from Table 3, one of the major reasons why TB can be made small in the medium of the embodiment is estimated to be irradiation of a short pulse using so-called relaxation oscillation. It is estimated from the analysis result that TB=0.32 μm is the limit of the conventional medium under the above-described conditions. TB=0.32 μm has been considered as hard to obtain under the above conditions. The analysis result suggests that a higher density is possible. When a laser pulse with a rise time of 1 ns or more is used, as in the prior art, there is no other choice but to decrease the margins of various characteristics for actual commercialization, although the implementation is not necessarily impossible. Hence, the method using relaxation oscillation is more preferable.

### EXAMPLE 2

When a lens having an NA of 0.85 was used as the objective lens, a 1.1-mm-thick polycarbonate (PC) substrate formed by injection molding was used as the substrate. The thickness of the cover layer on the light incident side was about 0.1 mm. As in Example 1, both land/groove recording and groove recording are usable. Only an example of groove recording will be explained below. The track pitch was 0.28 to 0.31 μm. That is, TP×NA/λ ranged from 0.588 to 0.651. Single-sided single-layer media and single-sided double-layer media each formed on the PC substrate surface with grooves using a sputtering apparatus, as in Example 1, will be described. However, the invention can also be practiced for a multilayer medium including three or more layers on a single side. In, e.g., a single-sided single-layer medium, an information layer was formed by sequentially forming Ag alloy, ZnS:SiO₂, interface layer, recording film layer, interface layer and ZnS:SiO₂ on the PC substrate surface with grooves using a sputtering apparatus. In a single-sided double-layer medium, an information layer L0 close to the light incident side was formed by sequentially forming ZnS:SiO₂, Ag alloy, ZnS:SiO₂, interface layer, recording film layer, interface layer, and ZnS:SiO₂ on the interlayer separation layer on an information layer L1. Additionally, the information layer L1 far from the light incident side was formed by sequentially forming an Ag alloy, ZnS:SiO₂, interface layer, recording film layer, interface layer, and ZnS:SiO₂ on the PC substrate. As systems having a smaller number of films, a single-layer medium in which Ag alloy, ZnS:SiO₂, recording film layer, and ZnS:SiO₂ were sequentially formed on the PC substrate, and a single-sided double-layer medium in which L0 was formed by forming ZnS:SiO₂, Ag alloy, ZnS:SiO₂, recording film layer, and ZnS:SiO₂ on the interlayer separation layer on L1, and L1 was formed by sequentially forming an Ag alloy, ZnS:SiO₂, recording film layer, and ZnS:SiO₂ on the PC substrate were also prepared. A medium in which ZnS:SiO₂, SiO₂, ZnS:SiO₂, recording film layer, ZnS:SiO₂, and Ag alloy were sequentially formed, and media including an interface layer inserted between the recording film and one or each of the dielectric films were also prepared as single-layer media.

The examined recording film materials and interface layer materials are the same as in Example 1.

An initializing apparatus crystallized the recording film on the entire surface (all tracks) of each medium. The interlayer separation layer made of a UV resin was 20 μm thick. Evaluation was done using a disk evaluation apparatus ODU-1000 available from Pulstec Industrial. The apparatus has a blue-violet semiconductor laser with a wavelength of 405 nm and an objective lens with NA=0.85. Recording experiments were conducted by the groove recording method. The remaining conditions are the same as in Example 1.

Table 4 shows the evaluation result. As shown in Table 4, in all samples of rewritable recording media, SbER was on the order of 10⁻⁵ or less. That is, a practical error rate was obtained. Even for analog data, CNR was 52 dB or more, and an excellent result was obtained. As for the write-once characteristic, SbER was on the order of 10⁻⁸. That is, a very satisfactory result was obtained.

TABLE 4

| | | | | | SbER |
|---|---|---|---|---|---|
| TB | TP × NA/λ | SbER | CNR [dB] | ER [dB] | (write-once) |
| 0.319 | 0.670 | 1.3 × 10⁻⁶ | 54.6 | 34.6 | 1.2 × 10⁻⁸ |
| 0.31 | 0.651 | 3.2 × 10⁻⁵ | 53.9 | 35.9 | 2.1 × 10⁻⁸ |
| 0.28 | 0.588 | 3.3 × 10⁻⁵ | 52.9 | 34.9 | 2.8 × 10⁻⁸ |

As described in this example, recording can be performed even when TB is small. If TB is small, the problems of crosstalk (XT) and cross-erase (XE) arise. In this example, however, they posed no problem. As in Example 1, it is estimated that the characteristics are improved by shortening the rise time of the laser irradiation beam to be used.

### EXAMPLE 3

When a wavelength of 780 nm was used, and a lens having an NA of 0.5 was used as the objective lens, a 1.2-mm-thick polycarbonate (PC) substrate formed by injection molding was used as the substrate on the light incident side. A cover layer having a UV resin was provided on the reflecting film side. As in Example 1, both land/groove recording and groove recording are usable. Only an example of groove recording will be explained below. The track pitch was 1.2 to 1.59 μm. That is, TP×NA/λ ranged from 0.769 to 1.091. When the track pitch is 1.6 μm, TP×NA/λ=1.026. Hence, the condition when the track pitch is 1.59 μm actually represents the condition when TP×NA/λ<1.026. In, e.g., a single-sided single-layer medium, an information layer was formed by sequentially forming ZnS:SiO₂, recording film layer, ZnS:SiO₂, and Ag alloy on the PC substrate surface with grooves using a sputtering apparatus. The examined recording film materials and interface layer materials are the same as in Example 1.

An initializing apparatus crystallized the recording film on the entire surface of each medium. Evaluation was done using a disk evaluation apparatus ODU-1000 available from Pulstec Industrial. The apparatus has an infrared semiconductor laser with a wavelength of 780 nm and an objective lens with NA=0.5. The linear velocity was set to 1.2 m/s. Recording experiments were conducted by the groove recording method. Among the indices, jitter values were measured in place of SbER. The remaining conditions are the same as in Example 1.

Table 5 shows the evaluation result. As shown in Table 5, in all samples of rewritable recording media, the jitter was 5% or less. That is, a practical value was obtained. Even for analog data, CNR was 54 dB or more, and an excellent result was obtained. As for the write-once characteristic, the jitter was 5% or less. That is, a very satisfactory result was obtained.

TABLE 5

| | | | | | Jitter [%] |
|---|---|---|---|---|---|
| TB | TP × NA/λ | Jitter [%] | CNR [dB] | ER [dB] | (write-once) |
| 1.59 | 1.019 | 4.3 | 55.8 | 36.5 | 4.4 |
| 1.2 | 0.769 | 4.7 | 54.9 | 35.9 | 4.3 |
| 1.0 | 0.641 | 4.8 | 54.8 | 36.4 | 4.4 |

As described in this example, recording can be performed even when TB is small. If TB is small, the problems of crosstalk (XT) and cross-erase (XE) arise. In this example, however, they posed no problem. As in Example 1, it is estimated that the characteristics are improved by shortening the rise time of the laser irradiation beam to be used.

### EXAMPLE 4

When a wavelength of 650 nm was used, and a lens having an NA of 0.6 was used as the objective lens, a 0.6- to 0.59-mm-thick polycarbonate (PC) substrate formed by injection molding was used as the substrate. In land/groove recording, grooves were formed at a track pitch of 0.59 to 0.739 μm. That is, TP×NA/λ ranged from 0.545 to 0.682. As in Example 1, both land/groove recording and groove recording are usable. Only an example of land/groove recording will be explained below. In, e.g., a single-sided single-layer medium, an information layer was formed by sequentially forming ZnS:SiO₂, interface layer, recording film layer, interface layer, ZnS:SiO₂, and Ag alloy on the PC substrate surface with grooves using a sputtering apparatus. The examined recording film materials and interface layer materials are the same as in Example 1.

An initializing apparatus crystallized the recording film on the entire surface of each medium. Evaluation was done using a disk evaluation apparatus ODU-1000 available from Pulstec Industrial. The apparatus has an infrared semiconductor laser with a wavelength of 650 nm and an objective lens with NA=0.6. The linear velocity was set to 6.98 m/s. Recording experiments were conducted by the groove recording method. Among the indices, jitter values were measured in place of SbER. The remaining conditions are the same as in Example 1.

Table 6 shows the evaluation result. As shown in Table 6, in all samples of rewritable recording media, the jitter was 6% or less. That is, a practical recording characteristic was obtained. Even for analog data, CNR was 53 dB or more, and an excellent result was obtained. As for the write-once characteristic, the jitter was 5% or less. That is, a very satisfactory result was obtained.

TABLE 6

| | | | | | Jitter [%] |
|---|---|---|---|---|---|
| TB | TP × NA/λ | Jitter [%] | CNR [dB] | ER [dB] | (write-once) |
| 0.739 | 0.682 | 5.3 | 54.8 | 35.3 | 4.5 |
| 0.65 | 0.600 | 5.2 | 54.9 | 35.8 | 4.8 |
| 0.59 | 0.545 | 5.8 | 53.7 | 35.2 | 4.9 |

As described in this example, recording can be performed even when TB is small. If TB is small, the problems of crosstalk (XT) and cross-erase (XE) arise. In this example, however, they posed no problem. As in Example 1, it is estimated that the characteristics are improved by shortening the rise time of the laser irradiation beam to be used.

### COMPARATIVE EXAMPLES 1-5

Comparative examples will be described below. As the comparative examples, a wavelength of 405 nm was used, and a lens having an NA of 0.65 was used as the objective lens. Evaluation was done using the same medium as in Example 1 and the conventional laser by setting the pulse rise time to 1.2 ns or more. Tables 7 and 8 show the evaluation results. As shown in Tables 7 and 8, in all samples of rewritable recording media, SbER on the order of 10⁻⁵ or less was obtained when TB was 0.34 or more. As for analog data, CNR was 52 dB or more, and an excellent result was obtained. Even for the write-once characteristic, SbER on the order of 10⁻⁵ or less was obtained when TB was 0.34 or more. Hence, it is supposed to be difficult to make TB much smaller than before.

TABLE 7

| | | | | | SbER |
|---|---|---|---|---|---|
| TB | TP × NA/λ | SbER | CNR [dB] | ER [dB] | (write-once) |
| 0.29 | 0.465 | 5.2 × 10⁻⁴ | 50.3 | 25.9 | 2.6 × 10⁻⁴ |

TABLE 8

| | | | | | SbER |
|---|---|---|---|---|---|
| TB | TP × NA/λ | SbER | CNR [dB] | ER [dB] | (write-once) |
| 0.3 | 0.481 | 5.9 × 10⁻⁴ | 52.9 | 34.9 | 2.6 × 10⁻⁴ |
| 0.31 | 0.498 | 4.3 × 10⁻⁴ | 52.6 | 34.8 | 2.0 × 10⁻⁴ |
| 0.32 | 0.514 | 2.9 × 10⁻⁵ | 52.8 | 30.9 | 3.9 × 10⁻⁵ |
| 0.339 | 0.544 | 1.7 × 10⁻⁶ | 53.7 | 34.6 | 1.6 × 10⁻⁸ |

As described above, it is possible to provide an excellent high-density optical recording medium satisfying 0.480≦TP×NA/λ<1.026, where TB is the track width or pit array width of the optical recording medium, NA is the numerical aperture of the optical system of the optical pickup used in a recording/playback apparatus for recording/playing back information on/from the optical recording medium, and λ is the wavelength.

The various modules of the apparatus described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical recording medium to be processed by a light beam having a wavelength λ and a lens having a numerical aperture NA, comprising:
one of a track and a pit array,
wherein a width of one of the track and the pit satisfies a condition 0.480≦TP×NA/λ<1.026.

2. The medium according to claim 1, wherein the wavelength λ is 405 nm, and the numerical aperture NA is 0.65.

3. The medium according to claim 1, wherein the wavelength λ is 405 nm, and the numerical aperture NA is 0.85.

4. The medium according to claim 1, which further comprises a recording film corresponding to the track, and
in which the recording film contains at least Ge, Sb, and Te, and a composition GeₓSb_{y}Te_{z} contained in the recording film is a composition that satisfies x+y+z=100 and is defined by x=55/z=45, x=45/z=55, x=10/y=28/z=42, and x=10/y=36/z=54 on a GeSbTe ternary phase diagram.

5. The medium according to claim 4, wherein the composition contained in the recording film is partially substituted with bismuth (Bi) and/or indium (In) and/or tin (Sn), the composition (Ge_{(1-w)}Sn_{w})ₓ(Sb₍₁₋ᵥ₎(Bi₍₁₋ᵤ₎Inᵤ)ᵥ)_{y}Te_{z} after substitution satisfies x+y+z=100, and w, v, and u satisfy conditions 0≦w<0.5, 0<v<1, and 0≦u≦0.7.

6. The medium according to claim 1, which further comprises a recording film corresponding to the track, and
in which the recording film contains at least Ge, Bi, and Te, and a composition GeₓBi_{y}Te_{z} contained in the recording film is a composition that satisfies x+y+z=100 and is defined by x=55/z=45, x=45/z=55, x=10/y=28/z=42, and x=10/y=36/z=54 on a GeBiTe ternary phase diagram.

7. The medium according to claim 1, which further comprises a recording film corresponding to the track, and
in which the recording film contains at least Ge, Sb, Te, and nitrogen (N), the composition GeₓSb_{y}Te_{z} contained in the recording film satisfies x+y+z=100 in a composition region defined by x=55/z=45, x=45/z=55, x=10/y=28/z=42, and x=10/y=36/z=54 on a GeSbTe ternary phase diagram, and nitrogen (N) is added in 1 to 5 at. % to a GeSbTe compound in the composition region.

8. The medium according to claim 7, wherein the composition contained in the recording film is partially substituted with bismuth (Bi) and/or indium (In) and/or tin (Sn), the composition (Ge_{(1-w)}Sn_{w})ₓ(Sb₍₁₋ᵥ₎(Bi₍₁₋ᵤ₎Inᵤ)ᵥ)_{y}Te_{z} after substitution satisfies x+y+z=100, and w, v, and u satisfy conditions 0≦w<0.5, 0<v<1, and 0≦u≦0.7, and
N is added in 1 to 5 at. % to one of GeSnSbTe, GeSnSbTeIn, GeSbTeIn, GeSbTeBiIn, GeSbSnTeBiIn, GeSbTeBi, GeSnSbTeBi, and GeSnSbTeBiIn compounds corresponding to the composition after substitution.

9. The medium according to claim 1, which further comprises a recording film corresponding to the track, and
in which the recording film contains at least Ge, Bi, Te, and nitrogen (N), the composition GeₓBi_{y}Te_{z} contained in the recording film satisfies x+y+z=100 in a composition region defined by x=55/z=45, x=45/z=55, x=10/y=28/z=42, and x=10/y=36/z=54 on a GeBiTe ternary phase diagram, and nitrogen (N) is added in 1 to 5 at. % to a GeBiTe compound in the composition region.

10. The medium according to claim 1, which further comprises a recording film corresponding to the track, and
in which the recording film contains at least Sb and Te, and in a composition SbₐTe₁₋ₐ contained in the recording film, a satisfies 0.6≦a≦0.81.

11. The medium according to claim 1, which further comprises a recording film corresponding to the track, and
in which the recording film contains at least Ga and Sb, and in a composition Ga_{b}Sb_{1-b} contained in the recording film, b satisfies 0.09≦b≦0.35.

12. The medium according to claim 1, which further comprises a recording film corresponding to the track, and
in which the recording film contains at least In and Sb, and in a composition In_{c}Sb_{1-c} contained in the recording film, c satisfies 0.15≦c≦0.4.

13. The medium according to claim 1, which further comprises a recording film corresponding to the track, and
in which the recording film contains at least Ga and Sb, and in a composition Ga_{d}Sb_{1-d} contained in the recording film, d satisfies 0.10≦d≦0.35.

14. The medium according to claim 1, which further comprises a recording film corresponding to the track, and
in which the recording film contains at least Ga, In, and Sb, and in a composition (InSb)ₑ(GaSb)₁₋ₑ contained in the recording film, e satisfies 0≦e≦1.

15. The medium according to claim 4, wherein at least one of layers in contact with the recording film is an interface layer selected from the group consisting of GeN, GeCrN, ZrO₂+Cr₂O₃, ZrSiO₄, ZrO₂₋ₓNₓ containing Y₂O₃, ZrO₂₋ₓNₓ+Cr₂O₃ containing Y₂O₃, and ZrSiO₄₋ₓNₓ.

16. The medium according to claim 10, wherein at least one of layers in contact with the recording film is a layer selected from the group consisting of SiN, GeN, and SiC layers.

17. An information playback apparatus comprising:
a laser which emits a light beam having a wavelength λ; and
an objective lens which has a numerical aperture NA and focuses the light beam emitted from the laser onto an optical recording medium,
wherein the information playback apparatus plays back information from an optical recording medium which has one of a track and a pit and satisfies a condition 0.480≦track or pit width TP×NA/λ<1.026.

18. The apparatus according to claim 17, wherein the wavelength λ is 405 nm, and the numerical aperture NA is 0.65.

19. The apparatus according to claim 17, wherein the wavelength λ is 405 nm, and the numerical aperture NA is 0.85.

20. An information playback method comprising:
emitting a light beam having a wavelength λ; and
focusing the emitted light beam onto an optical recording medium via an objective lens having a numerical aperture NA and playing back information from an optical recording medium which has one of a track and a pit and satisfies a condition 0.480≦track or pit width TP×NA/λ<1.026.

21. An information recording apparatus comprising:
a laser which emits a light beam having a wavelength λ; and
an objective lens which has a numerical aperture NA and focuses the light beam emitted from the laser onto an optical recording medium,
wherein the information recording apparatus records information on an optical recording medium which has one of a track and a pit and satisfies a condition 0.480≦track or pit width TP×NA/λ<1.026.

22. The apparatus according to claim 21, wherein the wavelength λ is 405 nm, and the numerical aperture NA is 0.65.

23. The apparatus according to claim 21, wherein the wavelength λ is 405 nm, and the numerical aperture NA is 0.85.

24. The apparatus according to claim 19, wherein the laser emits the light beam having the wavelength λ based on one of a waveform and a pulse train, in which a rise time of an optical pulse falls within a range of 0.1 to 0.9 ns (inclusive).

25. An information recording method comprising:
emitting a light beam having a wavelength λ; and
focusing the emitted light beam onto an optical recording medium via an objective lens having a numerical aperture NA and recording information on an optical recording medium which has one of a track and a pit and satisfies a condition 0.480≦track or pit width TP×NA/λ<1.026.
